(19) United States
(12) Patent Application Publication
(10) Pub. No.: US 2005/0055312 A1
(43) Pub. Date: Mar. 10, 2005

(54) Software control flow watermarking

(76) Inventors: Kelce Steven Wilson, New Carlisle, OH (US); Jason Dean Sattler, Beavercreek, OH (US)

Correspondence Address: BAKER & BOTTS, 30 ROCKEFELLER PLAZA, NEW YORK, NY, 10112, US

(21) Appl. No.: 10/920,672

(22) Filed: Aug. 18, 2004

Related U.S. Application Data
(60) Provisional application No. 60/495,858, filed on Aug. 18, 2003.

(51) Int. Cl. H04L 9/00

(52) U.S. Cl. 705/51

(57) ABSTRACT

The present invention is a system and method of software control flow watermarking including the steps of obtaining a program for protection, generating at least one watermark value using a formula or process from an external file, and placing the at least one watermark value in CASE values of the program. The system and method may further include determining the at least one watermark value by a formula with at least one variable. The formula may also contain a variable from outside of the program. The system may also stop the program if the variable from outside of the program is incorrect.

### RELATED APPLICATIONS

This application claims priority from U.S. Provisional Application Ser. No. 60/495,858, entitled “Software Control Flow Watermarking,” filed on Aug. 18, 2003, the disclosure of which is hereby incorporated in its entirety by reference.

### FIELD OF THE INVENTION

The present invention relates generally to embedding identifying information into a computer program, and more particularly relates to a method of providing software control flow watermarking.

### BACKGROUND OF THE INVENTION

Software “piracy” is a significant problem for the computer software industry. As a result, in order to protect the integrity of the authorship and ownership of computer software, and reduce the occurrences of illicit copying, techniques have been developed to track software programs and to disable software that has been modified by an unauthorized user. Techniques for protecting authorship by embedding information into the source code are often referred to as “watermarking.” Techniques to track unauthorized copying by embedding information into the source code are generally referred to as “fingerprinting.”

One of the traditional difficulties in watermarking software is in making the watermark an integral part of the program in such a way that it cannot be readily detected and removed. One existing solution to this is to insert identifying marks so thoroughly into the software development plan that tampering efforts are likely to destroy the logic and the reliability of the software itself before the embedded information is fully removed. A problem with this approach is that the watermarking adds to development complexity and could limit the programming style of the individual programmers. Additionally, tying the logic of the program to uniquely identifiable features may introduce errors or “bugs” in the software under development, and changing the watermark to allow fingerprinting can be tedious and prohibitive.

Another solution is to insert additional variables or logic into the program after the primary logic has been validated. However, in this case, the likelihood that removing the watermark may still allow the program to function properly increases. Furthermore, the compiler, which converts the source code to object code, may alter the structure of the program, thus removing or altering all or part of the intended watermark.

Cloakware Corporation, of Ottawa, Canada has an approach to watermarking that uses what is referred to as branch flattening technology. In this approach, hierarchical program execution is transformed into a minimum number of SWITCH statements and new CASE variables are introduced. The portion of the program executed by each CASE option updates the CASE variable and sends the execution point back through a SWITCH statement via a GOTO point placed just prior to a SWITCH. In the Cloakware approach, CASE values are automatically generated by their TransCoder software, and appear to be a series of sequential numbers with an arbitrary initial seed value.

FIG. 3 shows software code of the Cloakware TransCoder using sequential coding. The TransCoder program logic flow is controlled by a SWITCH statement. The SWITCH statement in this embodiment is:

switch(r_13968)
{

case 2135361786:
goto L_65_new;
case 2135361787:
goto L_13952;
case 2135361788:
goto L_13955;
case 2135361789:
goto L_97_new;
case 2135361790:
goto L_13958;
;

}

An exemplary CASE variable is r_{—}13968. An exemplary CASE value assigned to a CASE variable is case 2135361786.

While this approach is effective, since the CASE values take the form of a predictable sequence of numbers (i.e., sequential), a person interested in disabling this form of watermark can remove it by searching the code for the sequential CASE values.

Thus, a problem remains in the art to reliably and effectively insert a watermark or fingerprint into a computer program in a manner that is relatively simple for the designer to implement yet still provides a significant deterrent to potential copiers.

### SUMMARY OF THE INVENTION

One object of the present invention is to provide a system and method of watermarking computer software in a manner that is easy for the developer to insert, yet difficult for an attacker to remove.

It is another object of the present invention to provide watermarking software wherein the watermarking scheme and watermark values are publishable to software developers without the risk of compromising the integrity of the resulting watermark values.

It is another object of the present invention to increase tamper resistance in software.

In a first embodiment of the present invention, a method of software watermarking is provided which includes obtaining a program for protection, generating at least one watermark value using a formula or process, placing the at least one watermark value in a CASE variable, or in a formula to calculate the watermark value, and assigning corresponding watermark values to the variable used in the SWITCH statement or the variables used to calculate the CASE value. The values themselves are not created by a sequential counting algorithm as in the prior art, but instead are read in from a file containing results of a formula or process.

In an alternate embodiment, an extension may be added which uses a formula within the SWITCH statement to replace the CASE variable. A further extension may be added which uses an external value such as a password, dongle, biometric data, or internet data in the formula.

### BRIEF DESCRIPTION OF THE DRAWINGS

FIG. 1 is a flow chart illustrating a method of watermarking software in accordance with the present invention.

FIG. 2 is a screen shot view of an exemplary embodiment of a graphical user interface used in the present invention for generating at least one watermark value.

FIGS. 3A and 3B are software code of a prior art TransCoder program without watermarking as described in the present invention.

FIGS. 4A and 4B are a listing of an exemplary embodiment of software code after placing the at least one watermark value in the at least one CASE value, in accordance with the present invention.

FIG. 5 is a display of a binary file of software processed in accordance with the present watermarking methods showing inserted watermark values after compilation.

FIGS. 6A and 6B are a partial listing of computer software showing an alternate embodiment of the software code of the present invention.

FIG. 7 is a flow chart illustrating an alternate embodiment of the present invention.

### DETAILED DESCRIPTION OF THE PREFERRED EMBODIMENT OF THE INVENTION

In the present invention, rather than rely on a detectable series of sequential numbers as watermark values, at least a portion of watermark values are the result of a process or function, such as a hash function or an encrypted data stream. This approach can be used to provide a watermark for the software, so long as the watermark values that result from the selected function are not likely to be otherwise valid values of the CASE statement during program execution. That is, if a specific potential watermark value might be a legitimate data value in the program or an already existing CASE variable, then that value, and therefore that function, cannot be used. Thus, the primary constraints on the allowable watermark values are that the watermark value should not duplicate other values in the logic flow and that the watermark value does not cause compilation or runtime problems with the compiler.

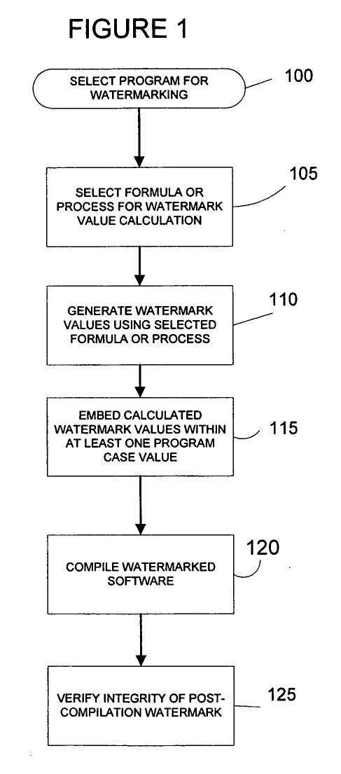

Referring to FIG. 1, a first method in accordance with the present invention is illustrated. In this method, a program or software module to be protected by the present invention is selected (step 100). A formula or process that will be used to generate watermark values is also selected (step 105). The formula or process of step 105 is selected such that the resulting watermark values will not be readily determined or detected in the final software. The formula or process selected in step 105 is further selected to generate watermark values which are not likely to be used in the normal course of run-time operation in the software. This minimizes the likelihood that the watermark values will effect the actual software operation. In one embodiment, the Secure Hash Standard 1 (SHA-1) can be applied to a pre-selected alphanumeric string in order to generate the watermark values.

The selected formula or process in step 105 is then used to generate at least one watermark value (step 110). For example, if SHA-1 is applied to the arbitrary phrase: “Watermarking test #1 for Cloakware's TransCoder,” the resulting watermark values in step 110 are: 3F498006, 25778F89, 6A2EF626, 252A7B1F, 1EBFF326. It will be appreciated that for the formula or process of step 105, many other hash values, encrypted data stream, or any other hex result chosen by the watermarking party may be used.

The watermark values generated in step 110 are then embedded in the software to be protected by placing the watermark value in at least one CASE statement as a CASE value (step 115). Since the formula of step 105 was selected to generate watermark values which are not likely to be encountered during execution of the program, the insertion of the watermark as a CASE value is unlikely to adversely effect program execution. After the watermark values are embedded, the program is compiled to generate an executable file (step 120). The integrity of the watermarking process can be verified by evaluating the compiled Hex file to identify the presence of the watermark value (step 125).

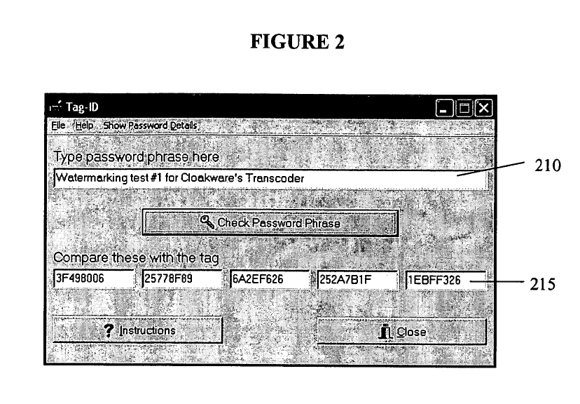

FIG. 2 shows an embodiment of a graphical user interface used in the method for generating at least one watermark value. The watermark values used in this example are the Secure Hash Standard 1 (SHA-1) values of the phrase: “Watermarking test #1 for Cloakware's Transcoder,” which is entered in data entry field 210. Of course, it will be appreciated that this is an arbitrary text string selected by the watermarking party. In the example where SHA-1 is used to generate watermark values from this string, the resulting watermark values in step 110 are: 3F498006, 25778F89, 6A2EF626, 252A7B1F, 1EBFF326, as shown in display field 125.

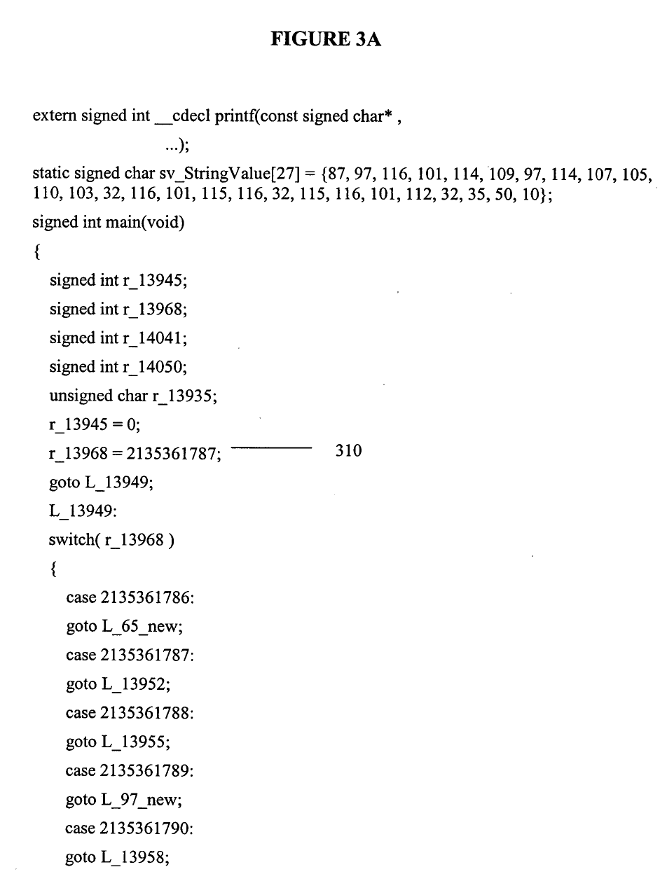

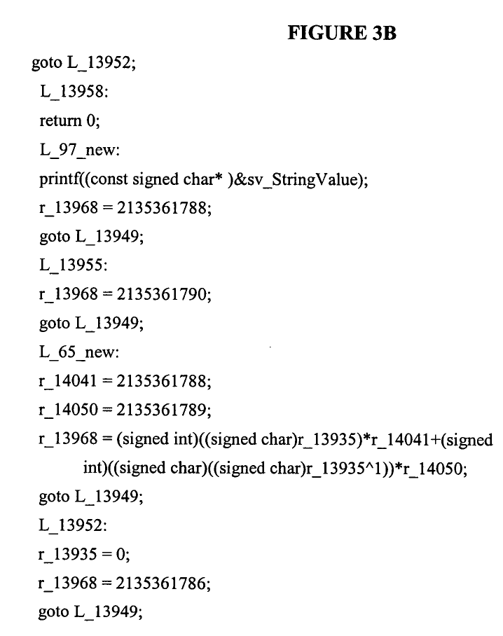

FIG. 3 illustrates a sample source code listing prior to watermarking.

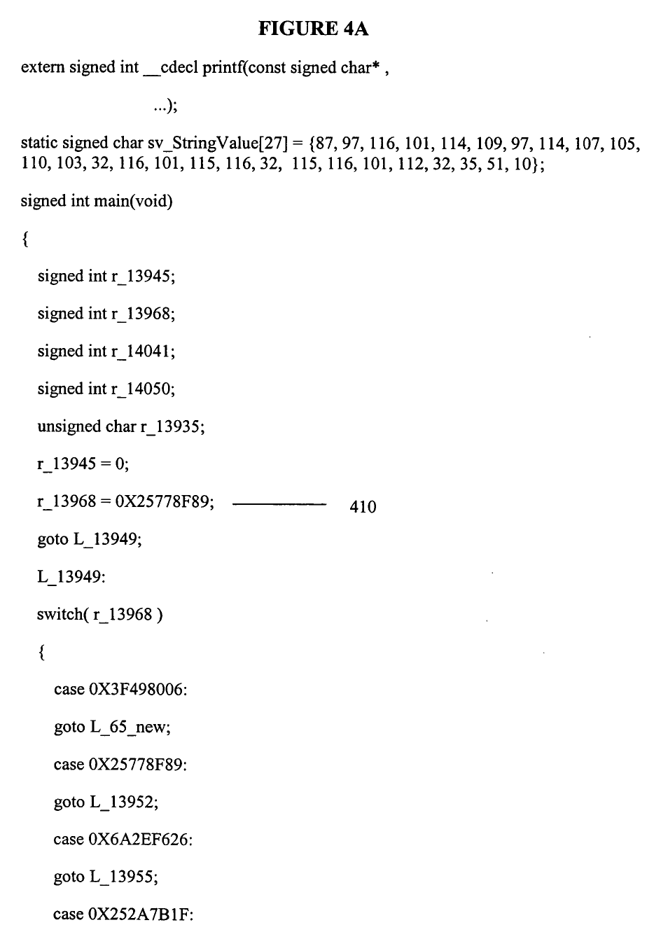

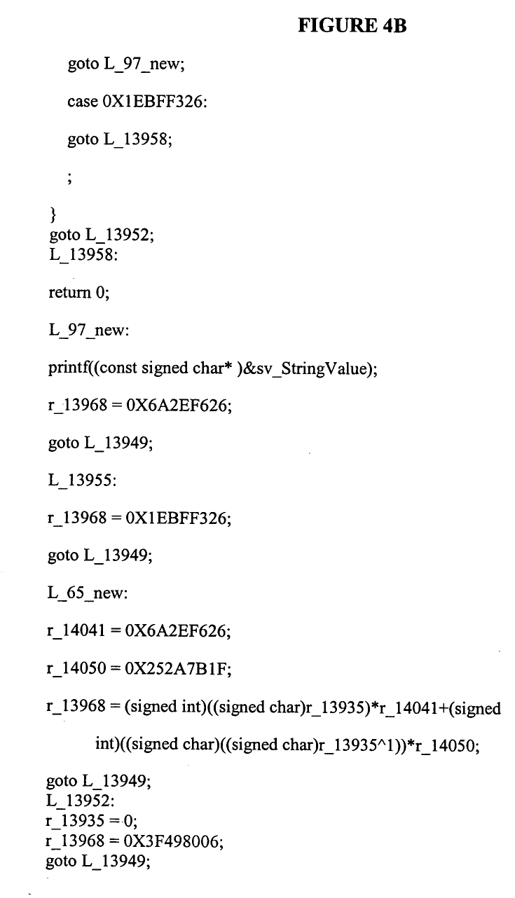

FIG. 4 shows software code after placing the at least one watermark value in the at least one CASE value. The watermark values are apparent by comparing, for example assignment 310, r_{—}13968=2135361787 in the unwatermarked code with assignment 410, r_{—}13968=OX25778F89 in the watermarked code of FIG. 4.

The TransCoder CASE values of FIG. 3 are substituted with watermark values in accordance with the present invention in FIG. 4. This is done in this embodiment by post-processing, but may be included as part of the TransCoder process or any other compiler's pre-processing step.

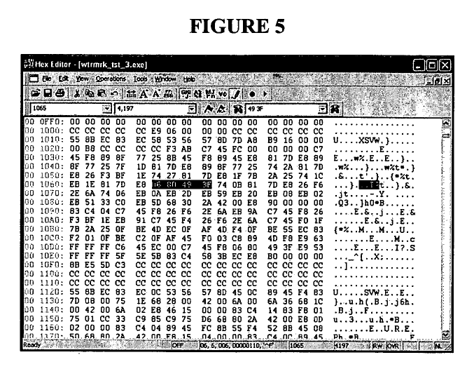

The software developer may then ensure that the watermark exists in a binary executable file (step 125). As shown in FIG. 5, a binary file editor can be used to verify the presence of the static watermark values in the program after compilation. Because of the complexity of compilers, not all watermark values may be present in the compiled code, but if enough values are seeded into the source code, a probability can be established that the software is effectually watermarked. Depending on the computer for which the program was compiled, the watermark values may be in reverse-byte order as shown in FIG. 5.

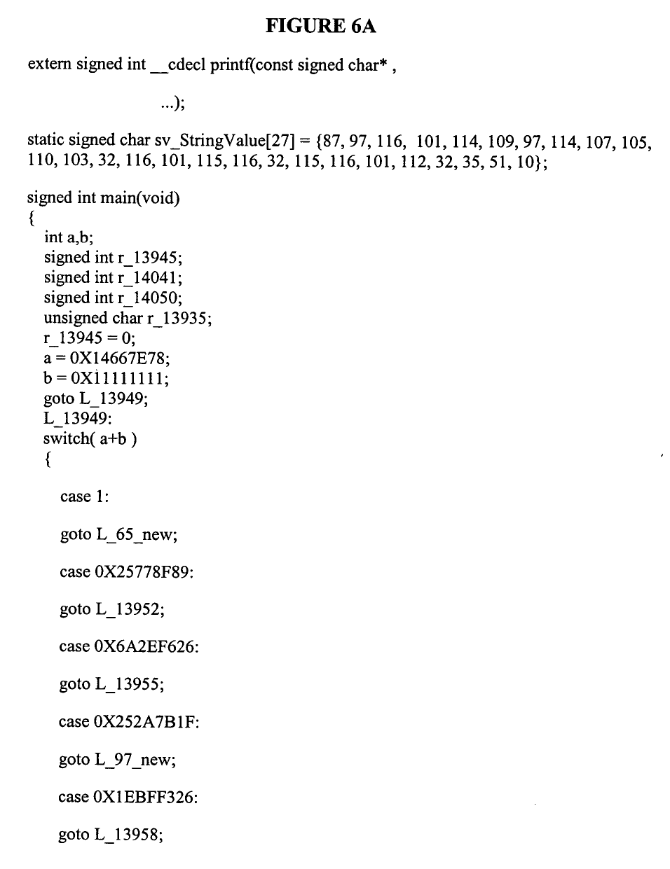

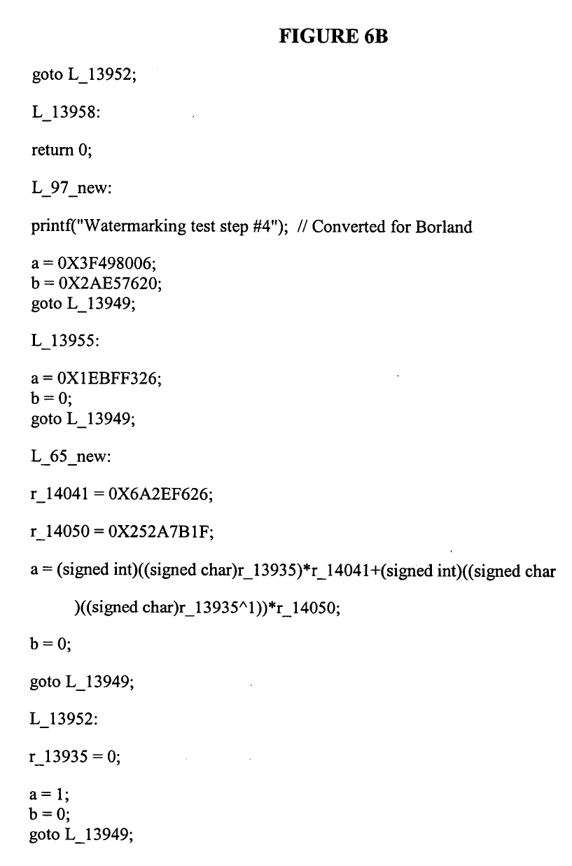

FIG. 6 shows a listing of software code for an alternate embodiment of the present invention. In this alternate embodiment, a SWITCH statement evaluates a formula, such as in the form “a+b”, where the variables “a” and “b” of the formula are assigned in a function prior to returning program control to the switch block.

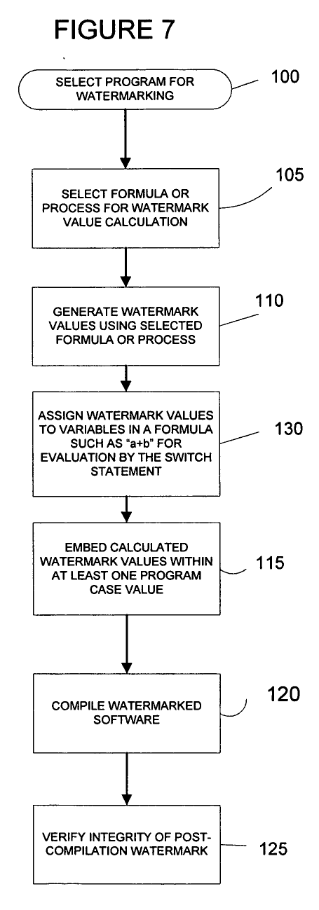

The flowchart of FIG. 7 illustrates an alternate embodiment of the present invention. In this alternate embodiment, a SWITCH statement evaluates a formula, such as in the form “a+b”, where the variables “a” and “b” of the formula are assigned in a function prior to returning program control to the switch block. In this embodiment, after the watermark values are generated, they are inserted into a formula such as “a+b” for evaluation by the switch statement (step 130). The formula calculates a watermark for insertion into at least one CASE value (step 115).

An advantage to using a function for evaluating the SWITCH statement is that the formula can calculate the watermark value immediately prior to use. As a result, the watermark values do not appear in a static form in the executable code in more than one location. In an alternate embodiment, the formula used to generate the watermark values can use other watermark values as the variables “a” and “b” to further reduce the likelihood that tampering will eliminate all embedded watermark values. The watermark values generated in this case are only visible during a dynamic analysis of the software.

Referring to FIG. 6, the variables “a” and “b” 610 have been inserted with an exemplary formula of “a+b” within the SWITCH statement, replacing the variable r_{—}13968 (410 in FIG. 4) with a watermark value. This formula can be simpler than the formula or process such as SHA-1. Note that the previous assignment of the CASE variable r_{—}13968 to 0X6A2EF626 (410 illustrated in FIG. 4) has been replaced by a=0X3F498006 and b=0X2AE57620 (610 in FIG. 6). Using the formula “a+b” for example, the proper CASE value is determined. The use of addition as the selected formula in 610 is only one of many potential formulas that can be used in this process. Also note that the value a=0X3F498006, used in the calculation of 0X6A2EF626, is another watermark value.

The use of a watermark value in the formula itself reduces the number of times each part of the watermark appears in the binary file, improving stealthiness and reducing the likelihood that the program will be tampered with. Also, since a formula is used in this embodiment, rather than assignment, multiple watermark values can be used in each CASE branch, one as the expected result and one or more as inputs to the evaluation. This approach further increases tamper resistance since multiple values must be removed simultaneously to remove the watermark which makes it difficult for a tampering party to preserve logic flow.

A further extension to the use of a formula to calculate a watermark value is to use an externally provided value, such as a password, biometric data, internet data or dongle for insertion into the formula. In such as case, the value of “a” can be provided during software development by the watermarking party and the value of “b” can be provided to the authorized user or purchaser of the protected software. At the time that the software is executed, the user may be prompted to enter the authentication data for variable b. If this value is not correctly input at run-time of the software or is not provided, the software program will stop execution. This will deter any unauthorized use of the program. Unlike conventional password protection, the present watermark is embedded into the software executable file making it difficult to remove or bypass.

The watermark values generated in accordance with the present invention are preferably implemented in a manner that generally survives the compilation process. One method to accomplish this objective is to embed the watermark values in sections of the source code that a compiler is not likely to eliminate or significantly modify during optimization. A normal GOTO statement using labels employs tokens that the compiler has the option of replacing. The present invention may perform a calculation that the compiler does not believe it has the option to replace. From the compiler's perspective, the calculation of the control-flow label is a necessary functionality rather than a sequential number. The compiler cannot distinguish the calculation from other program elements, and therefore does not remove it.

The present invention is not to be limited in scope by the specific embodiments described herein. Indeed, various modifications of the invention in addition to those described herein will become apparent to those skilled in the art from the foregoing description and accompanying Figures. Such modifications are intended to fall within the scope of the appended claims. Various references are cited herein, the disclosure of which are incorporated by reference in their entireties.

1. A method of software control flow watermarking comprising the steps of
obtaining a program for protection;
generating at least one watermark value using one of a formula or process; and
placing the at least one watermark value in at least one CASE value of the program.

2. The method of claim 1 wherein at least a portion of the at least one watermark value is determined by an internal formula with at least one variable.

3. The method of claim 2 wherein the formula includes at least one variable from outside of the program.

4. The method of claim 3 wherein the program stops if the at least one variable from outside of the program is incorrect.

5. A software control flow watermarking system comprising:
a program for protection;
software code for generating at least one watermark value using one of a formula or process; and
software code that places the at least one watermark value in at least one CASE value of the program.

6. The system of claim 5, further comprising software code which determines at least a portion of the at least one watermark value by an internal formula with at least one variable.

7. The system of claim 6 wherein the formula includes at least one variable from outside of the program.

8. The system of claim 7 wherein software code stops the program if the at least one variable from outside of the program is incorrect.
